(19) United States
(12) Patent Application Publication
(10) Pub. No.: US 2015/0106734 A1
(43) Pub. Date: Apr. 16, 2015

(54) EXPEDITED ACCESS TO A WEBSITE BY A MOBILE DEVICE

(71) Applicant: StartApp Mobile Technologies Ltd., Netanya (IL)

(72) Inventors: Ran AVIDAN, Zichron Yaakov (IL); Gil DUDKIEWICZ, New York, NY (US)

(73) Assignee: StartApp Mobile Technologies Ltd., Netanya (IL)

(21) Appl. No.: 14/053,635

(22) Filed: Oct. 15, 2013

(51) Int. Cl. G06F 3/0484; G06F 3/0481

(52) U.S. Cl. CPC G06F 3/04842; G06F 3/04817
USPC 715/745

(57) ABSTRACT

A method for expediting access to a website includes receiving by a server from a partner website an identification of a user device that has accessed the partner website via a browser. It is determined by the server that a designated software development kit (SDK) that includes an event receiver is installed on the user device. The partner website is instructed by the server to generate an event indicative of an offer of expedited access to the partner website from the user device that is receivable by the event receiver, and to install a shortcut on the user device for expedited access to the partner website if the offer is accepted.

### FIELD OF THE INVENTION

The present invention relates to mobile devices. More particularly, the present invention relates to a method of embedding a link to a website by a mobile device or other user device.

### BACKGROUND OF THE INVENTION

Mobile devices, such as smartphones, are provided with a mobile operating system. The mobile operating system includes a web browser that enables a user of the device to connect with a website. In addition, such devices are capable of downloading various applications from various sources.

In some ways, navigating to a website using a web browser of a mobile device is more difficult than similar operations on other types of computing devices, such as desktop or laptop personal computers. A typical mobile operating system limits that changes that may be made to the displayed user interface. For example, addition of icons may not be allowed by the mobile operating system, except via addition of downloaded applications. Navigating to a website using a web browser of a mobile device may require a number of steps that makes such navigation difficult or unpalatable to user of the device. Similarly, operations to add a visited website to a list of preferred websites or setting a website as a homepage may not be available, or may require more user operations than similar operations on other types of computers or with other types of operating systems.

### SUMMARY OF THE INVENTION

There is thus provided, in accordance with some embodiments of the present invention, A method for expediting access to a website, the method including: receiving by a server from a partner website an identification of a user device that has accessed the partner website via a browser; determining by the server that a designated software development kit (SDK) that includes an event receiver is installed on the user device; and instructing the partner website by the server to generate an event indicative of an offer of expedited access to the partner website from the user device that is receivable by the event receiver, and to install a shortcut on the user device for expedited access to the partner website if the offer is accepted.

Furthermore, in accordance with some embodiments of the present invention, installing the shortcut includes placing an icon on a home screen that is displayed by the user device.

Furthermore, in accordance with some embodiments of the present invention, the shortcut is operable to cause the user device to directly access the partner website via the browser.

Furthermore, in accordance with some embodiments of the present invention, the shortcut is operable to execute an application that causes the user device to access the partner website.

Furthermore, in accordance with some embodiments of the present invention, the application is configured to access a feature of the user device that is not accessible the partner website when accessed via by the browser.

Furthermore, in accordance with some embodiments of the present invention, installing the shortcut includes executing a function of the designated SDK.

Furthermore, in accordance with some embodiments of the present invention, determining that the designated SDK is installed includes determining that a partner application is installed on the user device.

Furthermore, in accordance with some embodiments of the present invention, instructing the partner website includes operating a code snippet of the partner website to generate the event.

Furthermore, in accordance with some embodiments of the present invention, the user device includes a smartphone.

There is further provided, in accordance with some embodiments of the present invention, a method for operation of a user device, the method including: installing on the user device a designated SDK including an event receiver; accessing a partner website; receiving from the partner website an event indicative of an offer of expedited access to the partner website by the user device; and installing on the user device a shortcut for expedited access to the partner website if the offer is accepted.

Furthermore, in accordance with some embodiments of the present invention, installing the designated SDK includes installing a partner application on the user device.

Furthermore, in accordance with some embodiments of the present invention, accessing the partner website includes providing an identification of the user device to the partner website.

Furthermore, in accordance with some embodiments of the present invention, providing the identification includes exchanging web cookies with the partner website.

Furthermore, in accordance with some embodiments of the present invention, installing the shortcut includes placing an icon on a home screen that is displayed by the user device.

Furthermore, in accordance with some embodiments of the present invention, installing the shortcut includes executing a function of the designated SDK.

Furthermore, in accordance with some embodiments of the present invention, the shortcut is operable to cause the user device to directly access the partner website via a browser that is installed on the user device.

Furthermore, in accordance with some embodiments of the present invention, the shortcut is operable to execute an application that causes the user device to access the partner website.

Furthermore, in accordance with some embodiments of the present invention, the application is configured to access a feature of the user device that is not accessible by a browser that is installed on the user device.

Furthermore, in accordance with some embodiments of the present invention, accessing the partner website includes navigating a browser that is installed on the user device to the partner website.

Furthermore, in accordance with some embodiments of the present invention, the user device includes a smartphone.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic illustration of a system for expedited access to a website by a user device, in accordance with embodiments of the present invention.

FIG. 2 is a block diagram of operation of the system illustrated in FIG. 1.

FIG. 3 is a flowchart depicting a server method for expedited access to a website by a user device, in accordance with an embodiment of the present invention.

FIG. 4 is a flowchart depicting a user device method for expedited access to a website by a user device, in accordance with an embodiment of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a user device (e.g., a mobile device such as a smartphone, portable computer, or other device provided with network browsing capability) is configured to browse a network environment (e.g., the Internet). Some of the websites that are accessible by the device are identifiable as partner web sites. A partner website is characterized by a snippet of code that is incorporated into the code that defines the website. For example, the partner website may be operated by an organization that subscribes to a service that is provided by a service provider. A processing of subscribing to the service may thus include incorporating the code snippet that characterizes a partner website into the code that defines the subscriber's website.

The service provider operates a server that is remote both to a computer that hosts the partner website (hereinafter the partner website host), and to the user device. The server communicates with one or more databases that include records of user devices on which cooperating software is installed.

When the user device navigates to the partner website, a component of the incorporated code snippet is executed. Execution of the component communicates with, or sends a notification to, the server. The communication includes notification to the server of the identity of the user device. Upon receiving the notification, the server searches a database in order to determine whether a cooperating event receiver is installed on the user device. The event receiver is configured to receive events that are generated by the partner website, or by another server or application that is associated with a provider of expedited access to the partner website. For example, the event receiver may have been installed together with a partner application on the user device. For example, the partner application may have been installed via the service provider, or via an application source that cooperates with the service provider. The event receiver be included in a designated software development kit (SDK) that is provided by the service provider and incorporated in the partner application. The designated SDK may thus incorporate the event receiver into the partner application. The designated SDK may include a library of additional functions, in addition to the event receiver. The event receiver is then installed on the user device as part of installation of the partner application.

For example, a code snippet that characterizes a partner website may include instructions to check whether the user device is listed in a database of devices on which the designated SDK had been installed. The code snippet may further include instructions to, if the user device is so listed, present a message to the user. For example, the message may offer to add the partner website to a (user friendly) launching facility that is external to the device browser. The code snippet may further include instructions to send an event to a receiver in the partner application on the designated SDK to create the offered site launcher.

If the search of the database indicates that the event receiver is installed on the database, an event is generated by the server that is detectible by the event receiver. Receipt of the event by the event receiver of the user device generates an offer of expedited access to the partner website. For example, expedited access may include creation of shortcut on the user device. Creation of the shortcut may include placement of an icon on a home screen or desktop display of the user device. (As used herein, “home screen” is used to designate a displayed user interface that provides access to icons that may be used to run or activated programs or applications, regardless of the particular operating system that is installed on the user device.)

The shortcut may enable direct access to the partner website via a browser that is installed on the user device. When activated by a user of the user device, the shortcut operates the browser to directly connects the user device to the partner website without any further action on the part of the user.

Alternatively or in addition, creation of the shortcut may include creation of an application that enables direct (e.g., not via the browser) access to the partner website. Activation of the shortcut by the user initiates execution of the application. The application then emulates operation of the partner website, emulates operation of the browser to access the partner website, otherwise enables access to the partner website, or performs two or more of the above. For example, the designated SDK of the partner application may duplicate or emulate all or part of the partner website within the host application of the user device. Such direct access to the partner website may be advantageous. For example, such direct access may enable access to features of the user device (typically not accessible by partner website when accessed via the browser) such as geographic location, sensors, and to local device information such as a contact list or other stored information.

For example, the offer may be in the form of a popup window. The popup window may include text or symbols that offer to the user the option of expedited access. For example, the text may ask the user if an icon is to be created on a home screen that is displayed on the user device. If the user accepts the offer, the icon is created. Subsequent selection of that icon may connect the user device with the partner website without any other actions on the part of the user.

If the offer of expedited access is rejected by the user, interaction of the user device with the partner website continues. In some cases, the offer of expedited access may be repeated at a later time. For example, the offer may be repeated if the user device remains connected to the partner website for more than a minimum period of time (or if a predetermined number or type of actions are executed during the time that the user device remains connected to the partner website). The offer may be repeated every time that the user device navigates to the partner website, after a predetermined number of times that user device navigates to the partner website, or when navigating to the partner website after a minimum period of time from a previous offer (e.g., so as not to annoy a user with an excessive number of offers).

Expedited access to a website on a user device, in accordance with embodiments of the present invention, may be mutually beneficial to the user of the user device, to the operator of the partner web site, and the provider of the service. The user of the user device may benefit from expedited access to information or services that are provided by the partner website. The operator of the partner website benefits from an increased number of users that visit the partner website, and thus increased revenues from advertisers or usage fees. Providing benefits to device users and to operators of partner websites may result in payment to the service provider for the services provided.

Expedited access to a website on a user device, in accordance with embodiments of the present invention, may be advantageous over other techniques and systems that are used to provide expedited access to websites. In accordance with embodiments of the present invention, no information regarding the user or the user device (excepted for minimal information that identifies the user device) need be provided to the partner website. Thus, expedited access in accordance with embodiments of the present invention may be advantageous over systems that require a user to log in or otherwise require providing identifying or characterizing information in order to attain expedited access to a website or other entity.

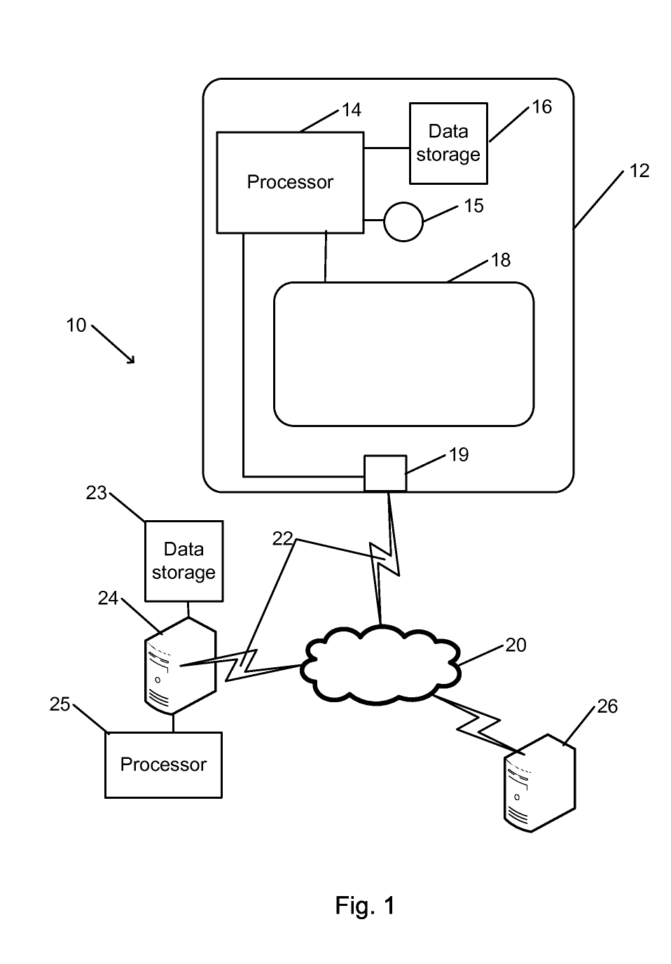

FIG. 1 is a schematic illustration of a system for expedited access to a website by a user device, in accordance with embodiments of the present invention.

Expedited website access system 10 includes user device 12. For example, user device 12 may include a stationary device, such as a personal computer, desktop computer, smart television, or other stationary device that enables a user to contact a website. User device 12 may include a mobile device, such as mobile phone, a smartphone, a handheld computer, a tablet computer, or other mobile device that enables a user to contact a website.

User device 12 includes processor 14. Processor 14 may include one or more processing units, e.g. that are incorporated into or associated with (e.g. connectable to) user device 12. Processor 14 may be configured to operate in accordance with programmed instructions. Processor 14 may be configured to execute an application for expedited access to a website on a user device, in accordance with embodiments of the present invention.

Processor 14 may communicate with output device 18. For example, output device 18 may include a computer monitor or display screen. Processor 14 may communicate with a screen of output device 18 to display a home screen, a user interface, or one or more icons. Alternatively or in addition, output device 18 may include a printer, display panel, speaker, or another device capable of producing visible, audible, or other output that is accessible to a user of user device 12.

Processor 14 may communicate with input device 15. For example, input device 15 may include one or more of a touch screen, keyboard, keypad, pointing device, microphone, or other device for enabling a user to input data, commands, or instructions for operation of processor 14.

Processor 14 may communicate with data storage device 16. Data storage device 16 may include one or more fixed or removable nonvolatile data storage devices. For example, data storage device 16 may include a computer readable medium for storing program instructions for operation of processor 14. Data storage device 16 may be utilized to store data or parameters for use by processor 14 during operation, or results of operation of processor 14.

It is noted that storage device 20 may be remote from processor 14. In such cases storage device 20 may be a storage device of a remote server storing programmed instructions module in the form of an installation package or packages that can be downloaded and installed for execution by processor 14.

User device 12 includes communications port 19. Communications port 19 may enable user device 12 to communicate with one or more remote or external devices via communications channel 22 and network 20. For example, user device 12 may communicate with server 24 or with partner website server 26 via communications port 19, communications channel 22, and network 20.

Communications channel 22 may include any wired or wireless communications channel (or a plurality of such channels operating concurrently or sequentially) that enables user device 12 to access network 20. Communications channel 22 may include two or more different communications channels, e.g., for different segments of communications channel 22 (e.g., a wireless communications channel connected to a wired communications channel).

Network 20 may include any wired or wireless communications network that enables communication between one device and another in an addressable manner. For example, network 20 may include one or more of a telephone network, a mobile phone network, an intranet, the Internet, or another network. Network 20 may include a combination of two or more intercommunicating networks.

Server 24 may communicate with one or more user devices 12 and with one or more partner website servers 26 via network 20 and one or more communications channels 22.

Server 24 includes server processor 25. For example, server processor 25 may be incorporated into, or otherwise be associated with, server 24. Server processor 25 may operate in accordance with programmed instructions.

Server 24 includes server data storage device 23. For example, server data storage device 23 may be in communication with server processor 25. Server data storage device 23 may include one or more fixed or removable nonvolatile data storage devices. For example, server data storage device 23 may include a computer readable medium for storing program instructions for operation of server processor 25. Server data storage device 23 may be utilized to store data or parameters for use by server processor 25 during operation, or results of operation of server processor 25. Server data storage device 23 may be utilized to store a database of user devices for use by server processor 25.

Programmed instructions for operation of server processor 25 may include instructions to execute a method for expedited access to a website on a user device, in accordance with embodiments of the present invention. For example, instructions may include instructions to receive information regarding a user device 12 from a partner website server 26, to search a database to determine whether an event receiver is installed on user device 12, to generate an event, to send an event to user device 12, or to provide expedited access to a partner website.

Partner website server 26 may communicate with one or more user devices 12 or with server 24 via network 20 and one or more communications channels 22. Partner website server 26 may be configured to provide or operate a partner website. Operation of the website may include providing a user interface, receiving data or commands from a user device 12, or sending data to a user device 12. For example, partner website server 26 may obtain an identification of a user device 12 that navigates to the partner website that is provided by partner website server 26. Partner website server 26 may then send the identification to server 24.

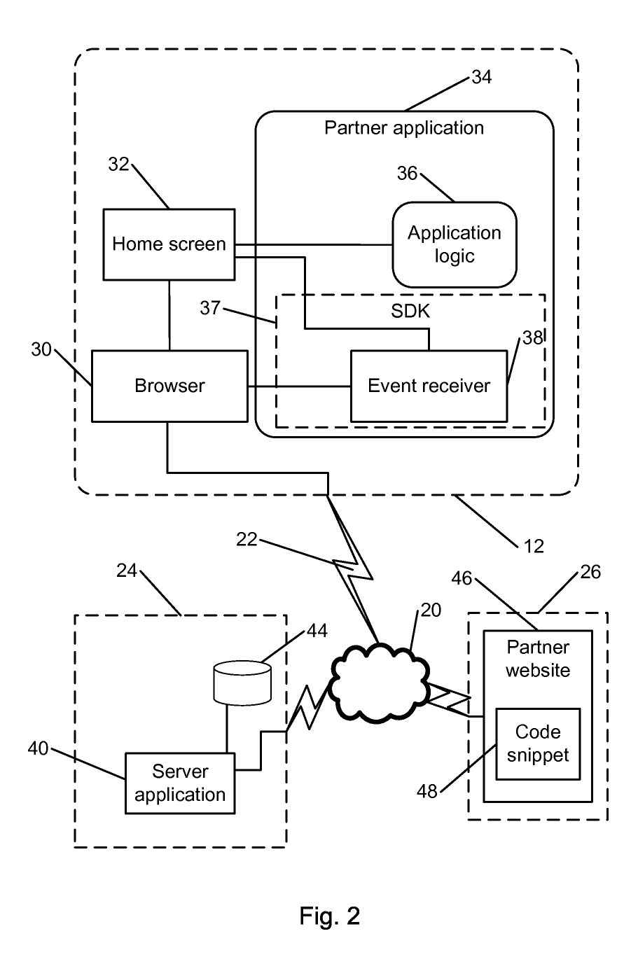

FIG. 2 is a block diagram of operation of the system illustrated in FIG. 1. In the discussion below, reference is made to components of expedited website access system 10 as shown in FIG. 1.

Processor 14 of user device 12 may execute one or more applications or programs. For example, home screen 32 may provide a user interface that enables activation of one or more applications. The user interface may be operated by coordinated operation of output device 18 and input device 15.

For example, operation of home screen 32 may activate operation of browser 30. Browser 30 enables user device 12 to navigate to or access one or more web sites via communications channel 22 and network 20. For example, browser 30 may enable user device 12 to access partner website 46.

Home screen 32 may be operated to install one or more applications on user device 12. For example, one or more partner applications 34 may be installed on user device 12. Installation of partner application 34 includes installation of application logic 36. Application logic 36 includes programmed instructions for operation of partner application 34 such that operation of partner application 34 performs its intended task.

Installation of partner application 34 also includes installation of designated SDK 37. designated SDK 37 may include a library of compiled functions. Among the functions installed as part of designated SDK 37 is event receiver 38. For example, event receiver 38 may be incorporated into partner application 36 by an designated SDK that was utilized to build partner application 34, or that is installed as part of partner application 34. Event receiver 38 is configured to detect one or more events of a predetermined form. For example, an event that is detectable by event receiver 38 may be generated by an event generator 42 that runs on a server 24. The generated event may be transmitted to user device 12 via network 20 and one or more communication channels 22. Event receiver 38 may operate in coordinated fashion with browser 30 to detect a generated event.

Upon detecting an event, event receiver 38 may operate in accordance with programmed instructions. For example, event receiver 38 may operate in coordinated fashion with home screen 32 (e.g., generate an interrupt command for home screen 32) to produce a notification. A user of user device 12 may receive the notification via home screen 32 and act accordingly. For example, the notification may offer expedited access to a partner website 46 via (e.g., a text message) output device 18. The user may indicate acceptance or rejection of the offer by operating input device 15 (e.g., selection of an appropriate screen control).

Home screen 32 may be operated to activate or run an installed application, such as partner application 34. For example, running partner application 34 includes operation in accordance with application logic 36.

Server processor 25 of server 24 may execute server application 40. Server application 40 may communicate with one or more partner websites 46 via network 20 and one or more communication channels 22.

For example, server application 40 may provide a code snippet 48 for incorporation into a partner website 48. Code snippet 48 may be provided, e.g., as part of a subscription process or other process in which a website is set up as, or is converted to, a partner website 48.

Server application 40 may receive identifying information from partner website 46 regarding a user device 12 that accesses partner website 46. The identifying information may correspond to a standard device identification protocol or standard known in the art. The identifying information may be generated by code snippet 48 of partner website 46 when partner website 46 is accessed by a user device 12.

Server application 40 may retrieve information related to an identified user device 12 from database 44. Database 44 may be stored on server data storage device 23. Data in database 44 may be organized (e.g., indexed) to enable searching or retrieval of information that is related to an identified user device 12. For example, the information may include an indication of whether event receiver 38 is installed on that user device 12. Other information may be included in database 44. Additional information may include, for example, a list of partner applications 34 that are installed on user device 12, version numbers related to an event receiver 38 or partner application 34 that is installed on user device 12, a list of partner websites 46 to which expedited access by user device 12 is enabled, or other data.

Server application 40 may generate instructions. For example, information that is retrieved from database 44 may indicate that an event receiver 38 is installed on a user device 12 that accessed partner website 46. Retrieved information may further indicate that expedited access to partner website 46 by user device 12 is not enabled. Server application 40 may generate an instruction to partner website 46 to operate code snippet 48 to generate an event that is detectable by event receiver 38. For example, the event may include a web cookie that is sent to browser 30 of user device 12 (via network 20 and communications channels 22). When detected by event receiver 38, an offer of expedited access by user device 12 to partner website 46 may be generated.

Partner website 46 is provided by operation of partner website server 26. Partner website 46 may enable access by one or more user devices 12. For example, access to partner website 46 may provide user device 12 with information or a service.

Partner website 46 is configured to detect access by a user device 12. Partner website 46 is further configured to determine an identity of an accessing user device 12. For example, identifying information may be obtained from user device 12 by an exchange of web cookies.

Partner website 46 incorporates code snippet 48. Code snippet 48 includes programmed instructions to send obtained identifying information regarding an accessing user device 12 to server 24. Code snippet 48 may include programmed instructions for other functionality. For example, code snippet 48 may enable identifying an instance of expedited access to partner website 46 by a user device 12. Such an instance of expedited access may be reported to server 24 (e.g., for billing purposes, or for the purpose of enabling further communication between server 24 and user device 12).

Server processor 25 is configured to execute a method for expedited access to a website by a user device.

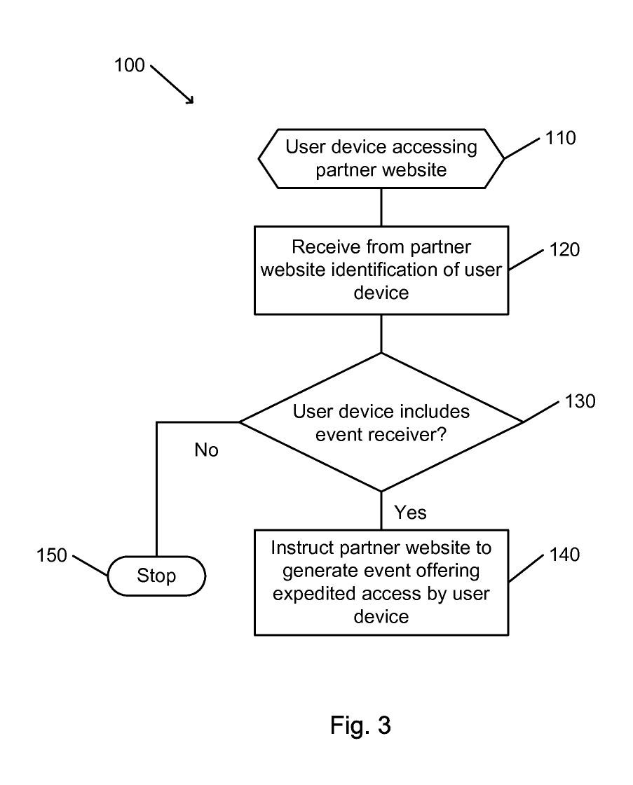

FIG. 3 is a flowchart depicting a server method for expedited access to a website by a user device, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Server expedited access method 100 may be executed by a processor of a server of a system for expedited access to a website by a user device.

Server expedited access method 100 may be executed when a user device accesses a partner website (block 110). Access by the user device may be detected by (e.g., via operation of a code snippet that is incorporated into) the partner website that is provided by a partner website server. The partner website may determine an identity of the user device, of a user that is logged in the user device, or both. For example, the identity may be determined by an exchange of web cookies between the user device and the partner website. The identity may be in accordance with a standard identification protocol or standard.

The partner website may then send a notification (e.g., in the form of a web cookie or other form) to the server. For example, the code snippet within the partner website may send a request to identify the user (using a cookie or similar technology). The notification includes an identity of the partner website.

The server receives an identity of the user device (e.g., including an identity of a user of the user device) from the partner website (block 120). For example, the identity of the user device may be received as part of the notification by the partner website, or during further communication between the server and the partner website (e.g., exchange of web cookies, or other data exchange technique).

The server checks a database to determine whether or not a designated SDK that includes an event receiver is installed on the user device (block 130). For example, the designated SDK may have been installed on the user device as part of installation of a partner application on the user device. The partner application may have been installed via the server, via a service that operates the server, or via a service that cooperates with the server. When the partner application is installed on a user device, the server may be informed (e.g., via a web cookie). The server may update the database with information regarding the user device and the installed partner application, designated SDK, or event receiver.

For example, the database may include a list of user devices and information that relates to each of the user devices. The information may include one or more of a list of partner applications that are installed on the user device, whether an event receiver is installed on the user device, a version of the event receiver, the designated SDK, or the partner application, a list partner websites to which expedited access is enabled, a date of installation, an indication that a partner or event receiver was uninstalled or removed (or a date of such removal), or other information. The database may be indexed or otherwise searchable to retrieve information regarding a user device. Other searches of the database may be enabled (e.g., under other circumstances).

If the user device is not included in the database, or the database indicates that no relevant designated SDK or event receiver is installed on the user device (e.g., none installed or wrong type or version installed), no instructions are given by the server to the partner website (block 150). If the user device is not included in the database, the server may add the user device to the database with an indication that no designated SDK or event receiver is installed. The user device may be added to a list of target devices to which installation of a partner application may be offered (e.g., via an exchange of web cookies, via an email message, or in another manner).

If searching the database reveals that an appropriate event receiver is installed on the user device, instructions are sent to the partner website to generate an event offering expedited access to the partner website by the user device (block 140). For example, the generated event may be detected by the event receiver of the user device. The code snippet of the partner website may activate a uniform resource identifier (URI) that is intercepted by the designated SDK on the partner application.

Detection of the generated event may initiate or trigger a sequence of operations to offer expedited access to the partner website. For example, a browser on the user device may be operated to request a user of the user device to indicate whether or not expedited access to the partner website is to be enabled. An indication of agreement may then initiate a sequence of operations to enable the expedited access. For example, the designated SDK of the user device may add an access point using the application programming interface (API) of the user device's embedded operating system.

For example, the user device may communicate with the server, with a partner website server, or with another server. The communication may result in installation of an icon or of another screen control, or otherwise enable (e.g., via a key sequence) expedited access to the partner website. Subsequent operation of the user device to indicate a request for expedited access (e.g., selecting the icon) may result in an immediate (e.g., without further action on the part of the user) connection of the user device to the partner website.

As another example, an application programming interface may be autonomously executed to add an icon to a home screen of the user device. Subsequent selection of the added icon then connects the user device to that partner website without any further action.

Selection of the icon or otherwise activation of the access point may cause the user device to directly contact the partner website using a browser that is installed on the user device. Alternatively or in addition, activation of the access point may initiate an application on the user device that emulates browsing to the partner website. The application may further be configured to access resources of the user device (e.g., a contact list or other resource).

A user device may be configured to execute a method to enable expedited access to a website by the user device.

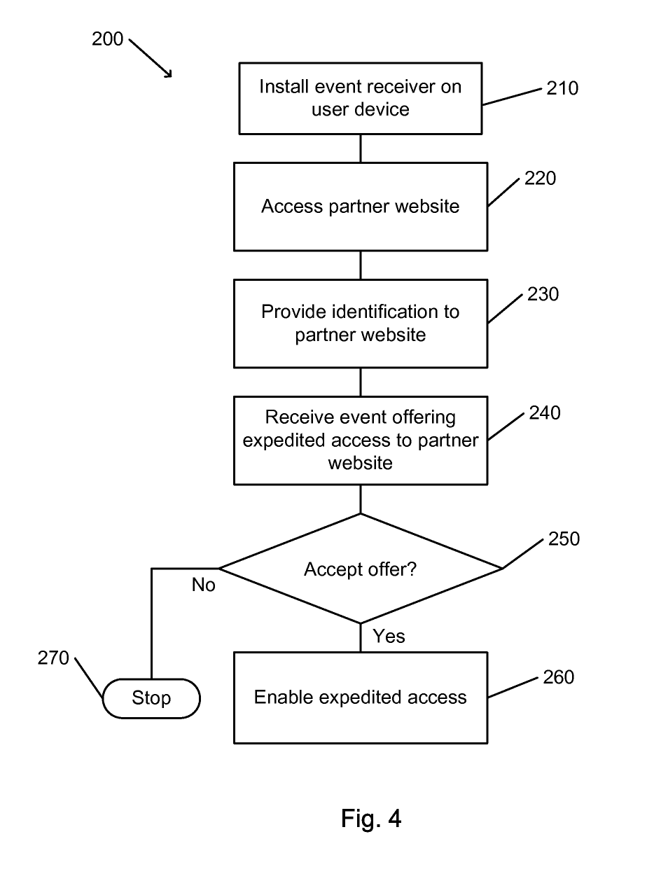

FIG. 4 is a flowchart depicting a user device method for expedited access to a website by a user device, in accordance with an embodiment of the present invention.

User device expedited access method 200 may be executed by a processor of a user device.

An event receiver of a designated SDK may be installed on a user device (block 210). For example, the designated SDK may be installed on the user device during installation of a partner application on the user device. The event receiver may be included as part of an designated SDK that is utilized in creation or modification of the partner application. For example, the partner application may be installed by communication of the user device with a server that is associated with a service that provides expedited access to a website.

As a result of installation of the event receiver or of the partner application, a database may be updated to reflect the installation. For example, the database may be maintained or accessed by a server that is associated with a service or system for enabling expedited access to a website. Thus, an identification of the user device may be included in the database.

A browser of the user device may be operated to navigate to and access a partner website via a network (block 220). The user of the user device may not be aware that a website is a partner website. Alternatively or in addition, a list or directory of user websites may be provided to the user (e.g., as a result of, or associated with, installation of the event receiver or partner application). The network may include the Internet or another network.

Access by the user device may be detected by the partner website being provided by a partner website server. The partner website may determine an identity of the user device, of a user that is logged in the user device, or both. For example, the identity may be determined by an exchange of web cookies between the user device and the partner website. The identity may be in accordance with a standard identification protocol or standard.

Information that identifies the user device may be provided to the partner website (block 230). For example, identifying information may be provided via an exchange of web cookies between the user device and the partner website.

The identifying information may be provided by the partner website to the server. Upon determination by the server that the event receiver is installed on the user device (e.g., by retrieving data from a database), the server may instruct the partner website to generate an event that is indicative of an offer for expedited access to the partner website. The server may have further determined that expedited access by the user device to the partner website is not yet enabled. For example, the event may be generated by operation of a code snippet that is incorporated into code that determines operation of the partner website.

The event that is generated by the partner website, and that is indicative of an offer for expedited access to the partner website, may be received by the event receiver (block 240). Receiving the event may include, or may result in, generation of a browser interrupt.

Receiving the event may include, or may result in, presentation of an offer for expedited access by the user device to the partner website. For example, an offer to create an appropriate icon on the home screen of the user device may be displayed or otherwise presented to the user.

Presentation of the offer may include enabling the user to accept the offer, or to reject the offer (block 250). For example, the user may select a screen control to indicate acceptance or rejection of the offer.

If the offer is rejected, no further action is performed regarding enabling expedited access to the partner website (block 270). For example, a window that displays a text message indicating the offer may be closed. The user device may continue to interact with the partner website.

If the offer is accepted, expedited access to the partner website is enabled (block 260). The partner website may interact with the user device to enable expedited access. Alternatively, functionality of the user device, e.g., of the designated SDK, may be operated to enable direct access. For example, enabling direct access may include creation of an icon or other screen control, or establishing a sequence of user actions. Subsequent activation of the enabled expedited access may cause a browser of the user device to directly access the partner website, without any further action on the part of the user. Alternatively or in addition, activation of the expedited access may run an application on the user device that emulates operation of the partner website, that emulates browser access to the partner website, that enables access by the partner website to resources of the user device (e.g., contact list or other resource), or two or more of the above.

1. A method for expediting access to a website, the method comprising:
receiving by a server from a partner website an identification of a user device that has accessed the partner website via a browser;
determining by the server that a designated software development kit (SDK) that includes an event receiver is installed on the user device; and
instructing the partner website by the server to generate an event indicative of an offer of expedited access to the partner website from the user device that is receivable by the event receiver, and to install a shortcut on the user device for expedited access to the partner website if the offer is accepted.

2. The method of claim 1, wherein installing the shortcut comprises placing an icon on a home screen that is displayed by the user device.

3. The method of claim 1, wherein the shortcut is operable to cause the user device to directly access the partner website via the browser.

4. The method of claim 2, wherein the shortcut is operable to execute an application that causes the user device to access the partner website.

5. The method of claim 4, wherein the application is configured to access a feature of the user device that is not accessible by the partner website when accessed via the browser.

6. The method of claim 1, wherein installing the shortcut comprises executing a function of the designated SDK.

7. The method of claim 1, wherein determining that the designated SDK is installed comprises determining that a partner application is installed on the user device.

8. The method of claim 1, wherein instructing the partner website comprises operating a code snippet of the partner website to generate the event.

9. The method of claim 1, wherein the user device comprises a smartphone.

10. A method for operation of a user device, the method comprising:
installing on the user device a designated SDK comprising an event receiver;
accessing a partner website;
receiving from the partner website an event indicative of an offer of expedited access to the partner website by the user device; and
installing on the user device a shortcut for expedited access to the partner website if the offer is accepted.

11. The method of claim 10, wherein installing the designated SDK comprises installing a partner application on the user device.

12. The method of claim 10, wherein accessing the partner website comprises providing an identification of the user device to the partner website.

13. The method of claim 12, wherein providing the identification comprises exchanging web cookies with the partner website.

14. The method of claim 10, wherein installing the shortcut comprises placing an icon on a home screen that is displayed by the user device.

15. The method of claim 10, wherein installing the shortcut comprises executing a function of the designated SDK.

16. The method of claim 10, wherein the shortcut is operable to cause the user device to directly access the partner website via a browser that is installed on the user device.

17. The method of claim 10, wherein the shortcut is operable to execute an application that causes the user device to access the partner website.

18. The method of claim 17, wherein the application is configured to access a feature of the user device that is not accessible by a browser that is installed on the user device.

19. The method of claim 10, wherein accessing the partner website comprises navigating a browser that is installed on the user device to the partner website.

20. The method of claim 10, wherein the user device comprises a smartphone.
